(19) United States
(12) Patent Application Publication
(10) Pub. No.: US 2004/0265656 A1
(43) Pub. Date: Dec. 30, 2004

(54) Electricity generation system comprising a fuel cell

(75) Inventors: Kenichi Hashizume, Gunma (JP); Timo O. Eriksson, Tokyo (JP)

Correspondence Address: HARRINGTON & SMITH, LLP, 4 RESEARCH DRIVE, SHELTON, CT, 06484-6212, US

(73) Assignee: NOKIA CORPORATION

(21) Appl. No.: 10/610,975

(22) Filed: Jun. 30, 2003

(51) Int. Cl. H01M 8/06

(52) U.S. Cl. 429/19; 429/34; 429/20

(57) ABSTRACT

A modular electricity generation system comprising:

a fuel storage tank, having a fuel type specific output interface;

a fuel reformer having an output interface and a fuel type specific input interface for connection with a corresponding fuel type specific output interface of a detachable fuel tank; and

a detachable fuel cell having an input interface for connection with the output interface of a plurality of different fuel reformers.

### FIELD OF THE INVENTION

The present invention relates to an electricity generation system comprising a fuel cell. In particularly relates to an electricity generation system suitable for hand-portable mobile devices, such as cellular mobile telephones.

### BACKGROUND TO THE INVENTION

The possibility of using fuel cells in mobile electronic devices is currently being actively researched. The focus of the research is on using a direct methanol fuel cell system. The direct methanol system uses a fuel storage tank and a fuel cell without an intervening fuel reformer. It could therefore potentially minimize the system size.

A problem with fuel cells, whether they include a reformer or not is that as they age their performance degenerates.

It would be desirable to provide an improved electricity generation system comprising a fuel cell.

### SUMMARY OF THE INVENTION

According to one aspect of the invention there is provided a modular electricity generation system comprising: a hydrogen supply module including a fuel reformer and having a first output interface; and a detachable fuel cell having a first input interface for connection with the first output interface of the hydrogen supply module.

The detachable fuel cell may be connected to any suitable hydrogen supply module and the first input interface of the detachable fuel cell may be arranged for connection with the first output interface of any one of a plurality of different hydrogen supply modules, each of which may use a different fuel and include a different reformer.

The hydrogen supply module may itself be modular, comprising: a detachable fuel storage tank module, having a second output interface; and a fuel reformer module providing the first output interface of the hydrogen supply module and having a second input interface for connection with the corresponding second output interface of the detachable fuel storage tank. The fuel cell module, fuel storage tank module and reformer module are separately user detachable.

The second output interface of the fuel storage tank may be fuel type specific and the second input interface of the fuel reformer may be fuel type specific. Consequently, the second input interface of a fuel reformer for reforming a first fuel type is connectable with a second output interface of a detachable fuel tank for storing the first fuel type but it is not connectable with a second output interface of a detachable fuel tank for storing a second different fuel type. Thus prevents an incorrect pairing of fuel and fuel reformer.

Generally a fuel reformer has a shorter lifetime than a fuel cell, but is cheaper. Thus the system has lower running costs by allowing the replacement of the reformer instead of the whole system.

The modular nature of the system enables a user to select the most advantageous hydrogen supply, which may change during time as new hydrogen generation systems are developed. The system is not tied to a single fuel type, but can use different fuel types.

### BRIEF DESCRIPTION OF THE DRAWINGS

For a better understanding of the present invention reference will now be made by way of example only to the accompanying drawings in which:

FIG. 1 illustrates a modular electricity generation system comprising three main components: a fuel storage tank, a fuel reformer and a fuel cell; and

FIG. 2 illustrates the interfaces between the main components of the system in cross-section.

### DETAILED DESCRIPTION OF EMBODIMENTS(S) OF THE INVENTION.

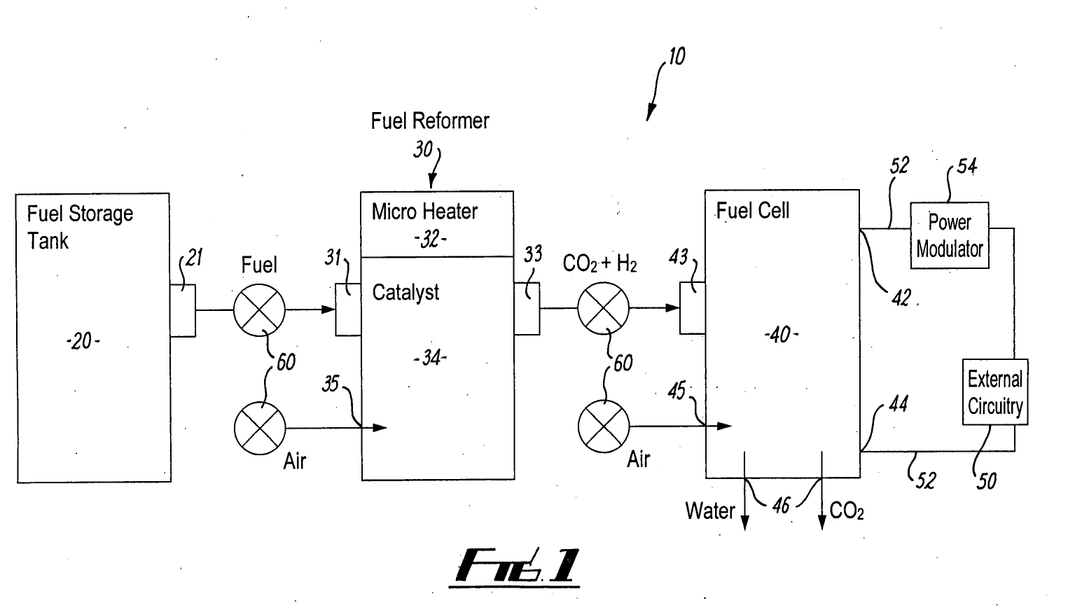

FIG. 1 illustrates a modular electricity generation system 10 comprising three main components: a fuel storage tank 20, a fuel reformer 30 and a fuel cell 40. The system 10 provides electrical power to external circuitry 50 via the electrical circuit 52.

The fuel storage tank 20 contains a particular fuel. The fuel may be any suitable fuel that contains hydrogen. It may for example be a solution of sugar, alcohol such as methanol, or hydrocarbons such as ethane, methane, butane, benzene, kerosene, gasoline or mixtures thereof. The fuel storage tank 20 has an output interface 21 that provides fuel to a corresponding input interface 31 of the fuel reformer 30. The design of the output interface is dependent upon the type of fuel the tank 20 is designed to store.

The fuel reformer 30 comprises: a micro-heater 32 and catalyst 34. The micro-heater 32 heats the catalyst 34 to temperatures of between 200° C. and 600° C. The fuel reformer has an input interface 31 for interfacing with the fuel storage tank 20, an output interface 33 for interfacing with the fuel cell 40 and, optionally a water inlet 35. The catalyst 34 comprises a transition metal such as copper, nickel, lead, zinc or oxides thereof. The type of catalyst used depends upon the type of fuel the reformer 30 is designed to reform. The catalyst reacts the fuel provided via the input interface 31 with water to produce CO₂, H₂ and CO. The water may be supplied via inlet 35 from the fuel cell 40, or included in the fuel mixture. The CO is removed from the fuel reformer 34 by another catalyst such as palladium. The remaining CO₂ and H₂ is then output from the fuel reformer 30 via the output interface 33.

The fuel cell 40 has an input interface 43 for interfacing with the output interface 33 of the fuel reformer 30, an anode 42, a cathode 44, an inlet 45, and a vent 46. The anode 42 is separated from the cathode 44 by a proton exchange membrane (PEM) or electrolyte (not shown). The anode 42 is impregnated with a noble metal catalyst that breaks down the hydrogen fed to the anode by the input interface 43 into protons and electrons. The protons pass through the proton exchange membrane to the cathode 44. The electrons pass through the electric circuit 52 including external circuitry 50 to the cathode 44. The cathode 44 is impregnated with a catalyst that promotes the combination of oxygen provided by inlet 45, with the protons and electrons to form water.

The CO₂ received via the input interface 43 and the water produced may be vented externally via the vent(s) 46. Alternatively, or in addition the water may be stored or returned to the fuel reformer 30 to dilute the fuel received via the input interface 31.

In order to stabilise the fuel cell, a power modulator 54 may be connected in the electrical circuit 52 between the fuel cell and external circuitry. The power modulator 54 stabilises the electrical output of the fuel cell 40. The power modulator 54 may comprise a sub-battery that acts as a buffer between the fuel cell 40 and the external circuitry 50. The power modulator 54 may additionally comprise a DC/DC converter.

The flow of fuel between the fuel storage tank 20 and the fuel reformer 30 may be controlled using a micro-pump 60 at the output interface 21 of the fuel storage tank or at the input interface 31 of the fuel reformer. The flow of reaction products between the fuel reformer 30 and the fuel cell 40 may be controlled using a micro-pump 60 at the output interface 33 of the fuel reformer or at the input interface 43 of the fuel cell. Alternatively a heater may be used at the fuel storage tank 20 to produces a pressure differential in the system 10 causing the fuel to flow from the fuel storage tank 20 to the fuel reformer 30 and fuel cell 40. Additionally or alternatively, the exhaust or evaporation of CO₂ from the fuel cell 40 may produce a pressure differential, causing the fuel to flow from the fuel storage tank 20 towards the fuel cell 40.

The inlets 35 and 45 may also have micro-pumps 60 for controlling the input of air to the fuel reformer 30 and the fuel cell 40 respectively.

Each fuel storage tank 20 is designed for use with a specific fuel type. Each specific fuel type should be reformed using a specific reformer 30 that has been designed to reform that fuel. Consequently, each fuel tank should be paired with a corresponding reformer with which it should be used. The pairing of a fuel tank for fuel A with a reformer for fuel A is achieved by pairing the interfaces between the tank and reformer.

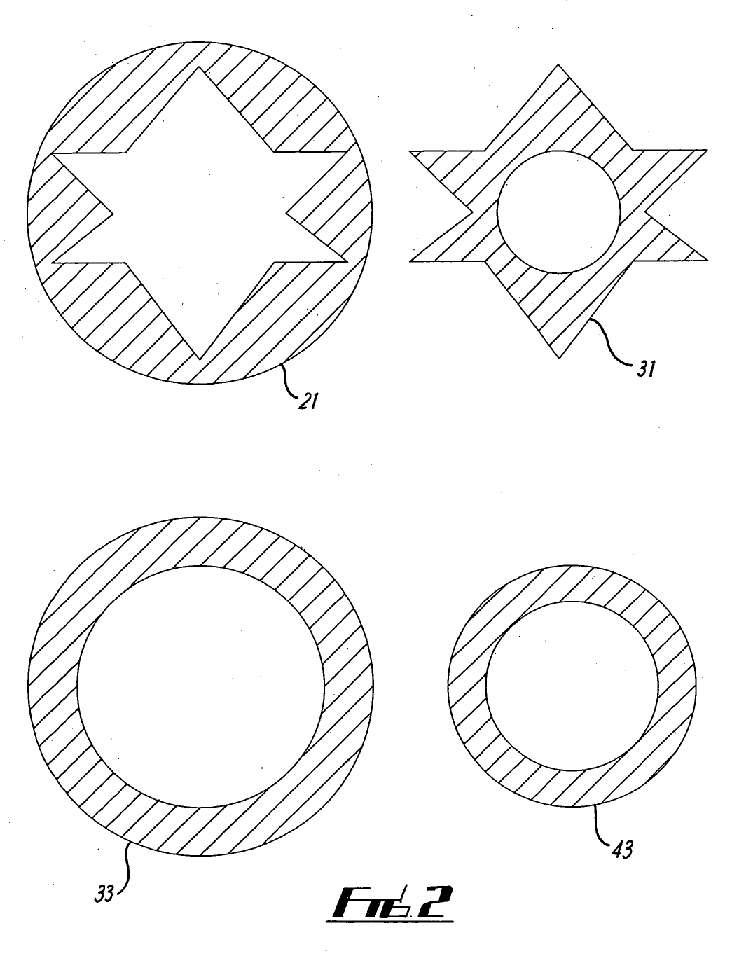

The combination of a fuel tank with an incorrect reformer is prevented by the configuration of the output interface 21 of the fuel tanks and the input interface 31 of the fuel reformers 30. The output interface 21 of a fuel storage tank 20 for fuel type A is designed so that it can mate with the input interface of the fuel reformer for fuel type A but cannot mate with the a fuel reformer for any other fuel type. FIG. 2 illustrates the characteristics of output interface 21. The interface 21 has a gas socket for receiving inside it a corresponding gas socket of the input interface 31 of the fuel reformer. The interior cross-section of the gas socket of the output interface 21 is uniquely irregular. The exterior cross-section of the gas socket interface 31 has corresponding unique irregularities so that it can fit into the gas socket of the output interface 21. A different pairing of fuel tank 20 and reformer 30 for a different fuel will have different corresponding uniquely irregular interfaces.

The output interface 33 of the fuel reformer is a generic interface common to fuel reformers irrespective of the fuel type for which it is designed. The input interface 43 of the fuel cell is also generic so that it mates with the output interface 33. They may be regular gas sockets and have a simple circular cross-section as illustrated in FIG. 2. The fuel cell 40 is independent of the fuel type used. This is because the pairing of fuel storage tank and fuel reformer breaks down the fuel into hydrogen for use in the fuel cell.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.”

1. A modular electricity generation system comprising:
a detachable hydrogen supply module including a detachable fuel reformer and a detachable fuel storage tank; and
a fuel cell for connection with any one of a plurality of different hydrogen supply modules.

2. A system as claimed in claim 1, wherein the detachable fuel storage tank, has a fuel-type specific output interface; and the detachable fuel reformer has a fuel-type specific input interface for connection with the corresponding fuel-type specific output interface of the detachable fuel storage tank.

3. A system as claimed in claim 1, wherein a fuel reformer for reforming a first fuel type has an input interface that is connectable with an output interface of a detachable fuel tank for storing the first fuel type but is not connectable with an output interface of a detachable fuel tank for storing a second different fuel type.

4. A system as claimed in claim 1, wherein each of the plurality of hydrogen supply modules uses a different fuel and includes a different reformer.

5. A system as claimed in claim 1, wherein the hydrogen supply module is user detachable.

6. A system as claimed in claim 1, wherein the fuel storage tank is user detachable.

7. A system as claimed in claim 1, wherein the fuel reformer is user detachable.

8. A system as claimed in claim 1, wherein the fuel storage tank comprises a heater.

9. A system as claimed in claim 1, wherein the fuel cell is arranged to provide water to a connected fuel reformer.

10. A system as claimed claim 1, wherein the fuel cell comprises at least one vent for venting carbon dioxide received from a connected fuel reformer.

11. A system as claimed in claim 1, wherein the fuel cell comprises an air inlet.

12. A system as claimed in claim 1, wherein the fuel reformer is for converting a first type of fuel into hydrogen.

13. A system as claimed in claim 1, wherein the fuel reformer includes a micro-heater and a transition metal catalyst.

14. A system as claimed in claim 1, wherein the fuel reformer comprises an air inlet.

15. A system as claimed in claim 1, wherein the fuel reformer is without vents.

16. A system as claimed in claim 1 comprising one or more micro-pumps.

17. A system as claimed in claim 1, further comprising power modulation circuitry.

18. An attachable/detachable fuel storage tank for use in a system as claimed in claim 1.

19. An attachable/detachable fuel reformer for use in a system as claimed in claim 1.

20. An attachable/detachable fuel cell for use in a system as claimed in claim 1.

21. An attachable/detachable hydrogen supply module for use in a system as claimed in claim 1.

22. A modular electricity generation system comprising:
a fuel storage tank, having a fuel type specific output interface;
a fuel reformer having an output interface and a fuel type specific input interface for connection with a corresponding fuel type specific output interface of a detachable fuel tank; and
a detachable fuel cell having an input interface for connection with the output interface of a plurality of different fuel reformers.

23. A modular electricity generation system comprising:
a detachable hydrogen supply module including a fuel reformer; and
a fuel cell for connection with the hydrogen supply module.
